(19) United States
(12) Patent Application Publication
(10) Pub. No.: US 2014/0214766 A1
(43) Pub. Date: Jul. 31, 2014

(54) STORAGE SYSTEM AND CONTROL DEVICE

(71) Applicant: FUJITSU LIMITED, Kawasaki-shi (JP)

(72) Inventor: Takako Kato, Inagi (JP)

(73) Assignee: FUJITSU LIMITED, Kawasaki-shi (JP)

(21) Appl. No.: 14/144,761

(22) Filed: Dec. 31, 2013

(30) Foreign Application Priority Data
Jan. 25, 2013 (JP) 2013-011694

(51) Int. Cl. G06F 11/14

(52) U.S. Cl. CPC G06F 11/1448
USPC 707/640

(57) ABSTRACT

A storage system includes a backup source storage, a backup destination storage, and a control device. The backup destination storage includes a first processor. The control device includes a second processor. The second processor is configured to acquire change history information on a history of changing data stored in the backup source storage. The second processor is configured to transfer the acquired change history information and differential data corresponding to the change history information to the backup destination storage. The first processor is configured to create, on basis of the change history information, a change list that indicates locations at which the data stored in the backup source storage is changed.

### CROSS-REFERENCE TO RELATED APPLICATION

This application is based upon and claims the benefit of priority of the prior Japanese Patent Application No. 2013-011694, filed on Jan. 25, 2013, the entire contents of which are incorporated herein by reference.

### FIELD

The embodiments discussed herein are related to a storage system and a control device.

### BACKGROUND

As illustrated in FIG. 13, in a storage system (file system) 100 connected to a host device 200 through a local area network (LAN) 300, data stored in backup source storage 120 is backed up by backup destination storage 130. The storage system 100 includes a server 110, the backup source storage 120, and the backup destination storage 130.

The server 110 manages the backup source storage 120 and the backup destination storage 130 and includes a processor 111, a memory 112, a memory controller 113, a network interface (I/F) 114, and a data I/F 115. The processor 111 executes processes of various types and control of various types. The memory 112 temporarily stores therein data to be written in the backup source storage 120 and data read from the backup source storage 120. The memory 112 also stores therein software to be executed by the processor 111 and a change list (described later). The memory controller 113 controls an operation of the memory 112. The network I/F 114 is connected to and communicates with the host device 200 through the LAN 300. The data I/F 115 is connected to the backup source storage 120 (data I/F 123) and executes data communication with the backup source storage 120.

The backup source storage 120 includes disks 121, a controller 122, and data I/Fs 123 and 124. The disks 121 store therein data to be accessed by the host device 200 and metadata on the data. The controller 122 controls, in accordance with instructions from the host device 200 and the server 110, access to the disks 121 and transfer of data stored in the disks 121 so that the backup destination storage 130 may back up the data. The data I/F 123 is connected to the server 110 (data I/F 115) and executes data communication with the server 110. The data I/F 124 is connected to the backup destination storage 130 (data I/F 133) and executes data communication with the backup destination storage 130.

The backup destination storage 130 includes disks 131, a controller 132, the data I/F 133, and a network I/F 134. The disks 131 store therein backup data stored in the backup source storage 120 (disks 121). The controller 132 controls access to the disks 131 and backup of data in accordance with instructions from the host device 200, the server 110, and the backup source storage 120. The data I/F 133 is connected to the backup source storage 120 (data I/F 124) and executes data communication with the backup source storage 120. The network I/F 134 is connected to and communicates with the host device 200 through the LAN 300.

In order to back up data stored in the storage system (file system) 100 illustrated in FIG. 13, the data stored in the disks 121 is fully copied from the backup source storage 120 to the backup destination storage 130. Specifically, first, all the data stored in the disks 121 and to be backed up is copied into the disks 131 of the backup destination storage 130 and stored as full backup data in the disks 131. Then, data (differential data) changed on the disks 121 of the backup source storage 120 is acquired at a certain time, transferred from the backup source storage 120 to the backup destination storage 130, and stored in the disks 131. Thus, the data stored in the disks 121 of the backup source storage 120 and to be backed up is backed up by the disks 131 of the backup destination storage 130.

In order to acquire the differential data, the server 110 references all regions of metadata stored in the disks 121, checks time stamps of all the regions, and recognizes a region (data block) in which data has been changed after the previous acquisition of differential data, as illustrated in FIG. 14, for example. Then, the server 110 creates a change list including information specifying the region in which the data has been changed after the previous acquisition of the differential data. The server 110 stores the change list in the memory 112.

The server 110 executes backup software stored in the memory 112 so as to create the change list. The created change list is used to recognize the differential data to be acquired and is used to create data at a desired time from the full backup data stored in the disks 131 of the backup destination storage 130 and the differential data.

Related techniques are disclosed in, for example, Japanese Laid-open Patent Publications No. 11-120057 and Japanese Laid-open Patent Publications No. 2001-290686.

In order to back up the differential data in the aforementioned manner, all regions of the metadata is scanned and the change list is created even if a part of data to be backed up has been changed. Thus, changing of data to be backed up is locked during checking of changes and the creation of the change list, and there is time before data is updated. Thus, the performance of the system is reduced. In most of existing systems, therefore, data is backed up during nighttime hours in which loads are low. In recent years, however, business systems are normally operated without being stopped due to globalization and implementation of virtualized environments. Thus, in Japan, it is difficult to stop a system even at night.

### SUMMARY

According to an aspect of the present invention, provided is a storage system including a backup source storage, a backup destination storage, and a control device. The backup destination storage includes a first processor. The control device includes a second processor. The second processor is configured to acquire change history information on a history of changing data stored in the backup source storage. The second processor is configured to transfer the acquired change history information and differential data corresponding to the change history information to the backup destination storage. The first processor is configured to create, on basis of the change history information, a change list that indicates locations at which the data stored in the backup source storage is changed.

The objects and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating a hardware configuration and functional configuration of a storage system according to an embodiment;

FIG. 2 is a diagram illustrating a commit for a journal in the storage system illustrated in FIG. 1;

FIG. 3 is a diagram illustrating operations of the storage system illustrated in FIG. 1;

FIG. 4 is a flowchart illustrating operations of the storage system illustrated in FIG. 1;

FIG. 5 is a flowchart illustrating operations of the storage system illustrated in FIG. 1;

FIG. 6 is a flowchart illustrating operations of the storage system illustrated in FIG. 1;

FIG. 7 is a sequence diagram illustrating operations of the storage system illustrated in FIG. 1;

FIG. 8 is a diagram illustrating a specific example of a journal managed in an embodiment;

FIG. 9 is a diagram illustrating a specific example of a journal managed in an embodiment;

FIG. 10 is a diagram illustrating a specific example of a journal management table according to an embodiment;

FIG. 11 is a diagram illustrating a specific example of a change list created from the journal management table illustrated in FIG. 10;

FIG. 12 is a diagram illustrating a specific example of backup data restored on the basis of the change list illustrated in FIG. 11;

FIG. 13 is a block diagram illustrating an example of a configuration of a storage system; and

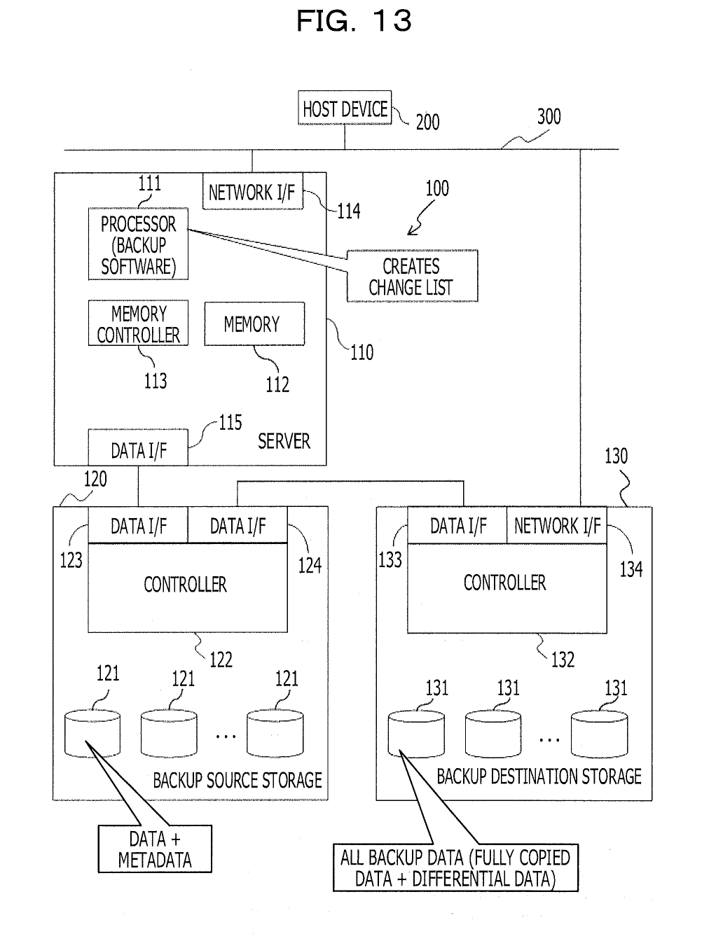

FIG. 14 is a diagram illustrating creation of a change list during backup of data in the storage system illustrated in FIG. 13.

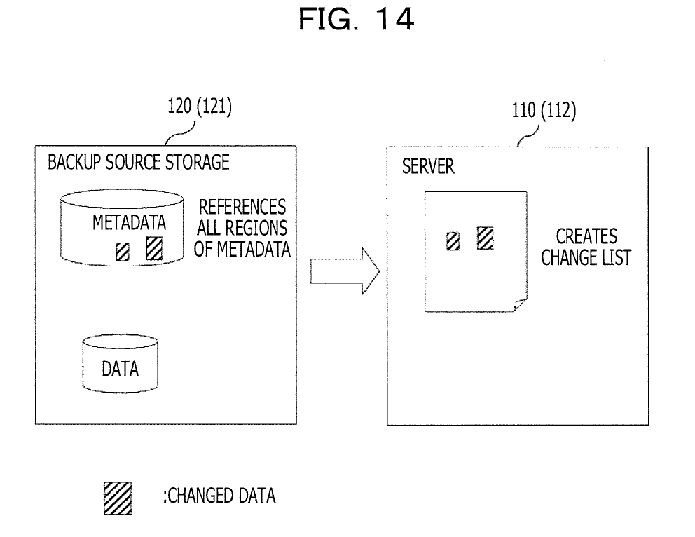

### DESCRIPTION OF EMBODIMENTS

Hereinafter, embodiments are described with reference to the accompanying drawings.

Configuration of Storage System According to First Embodiment

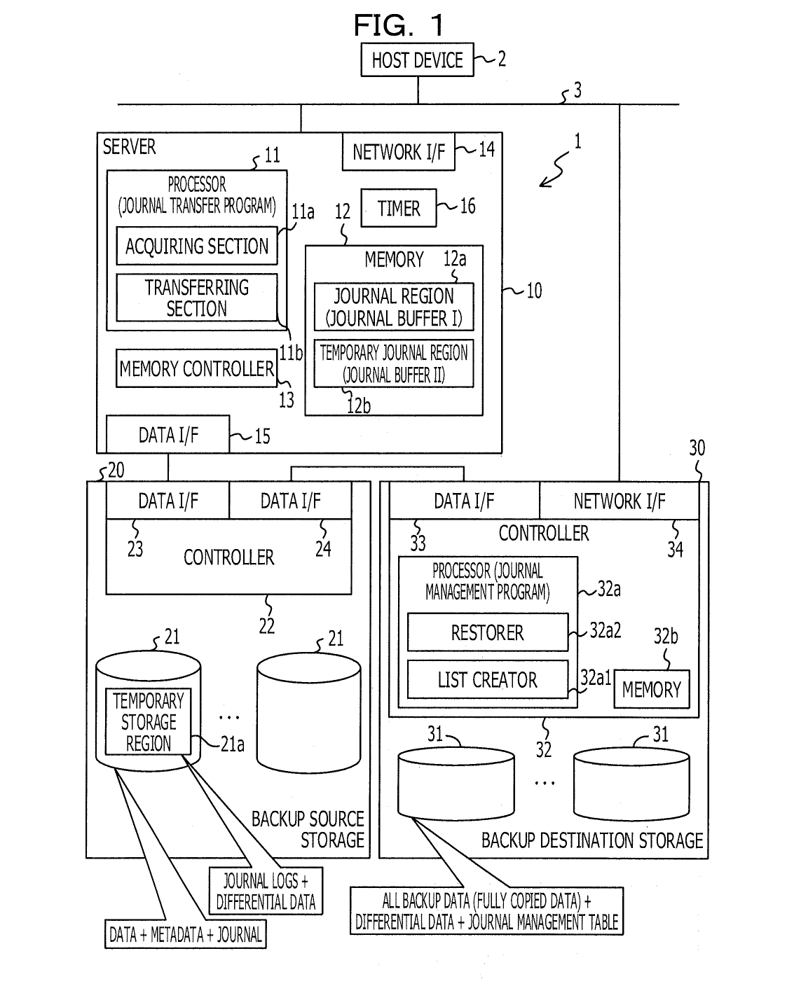

A hardware configuration and functional configuration of a storage system 1 according to a first embodiment are described with reference to FIG. 1. FIG. 1 is a block diagram illustrating the hardware configuration and functional configuration of the storage system (journal file system) 1 according to the first embodiment.

In the first embodiment, a journal file system is used as the storage system 1. In the journal file system, metadata and change histories of data are stored as journal logs in a journal buffer 12a before writing of the data in disks 21 in order to improve the consistency of the data. The first embodiment describes the case where the journal mode of ext3 (third extended system) that is used for Linux (registered trademark) is used as a journal scheme (journal file system).

The journal scheme of ext3 of Linux has three types of modes, the journal mode, an ordered mode, and a writeback mode. Any of the three modes may be used in the first embodiment.

The journal mode is to log both metadata and actual data in a journal. In the journal mode, the consistency of data is the highest, while any part of data is not inappropriately left after an unclean system shutdown. Since the journal mode is to log all operations in the journal, the speed of writing data in the disks 21 is low.

The ordered mode is to log only metadata in the journal. The order of writing data is guaranteed so that the actual data is written on the disks 21 before writing of the metadata. In the ordered mode, the metadata does not indicate inappropriate data. Since the metadata is logged in the journal, the metadata is properly restored even after an unclean system shutdown.

The writeback mode is to log only metadata in the journal and not to log the actual data in the journal. In the writeback mode, it is uncertain whether the actual data or the metadata is first written in the disks 21.

Although the first embodiment describes the case where the journal file system is the journal scheme (journal mode) of ext3 of Linux, the first embodiment is not limited to this. For example, the first embodiment is applicable to a journaled file system (JFS) and a Reiser file system (ReiserFS). The JFS and the ReiserFS manage the journal logs in different manners as described below, or methods for writing data in disks from a memory by the JFS and the ReiserFS and the timing of the writing by the JFS and the ReiserFS are different as described below. In the JFS, the journal logs are first stored in the memory and then written in the disks from the memory by a flash daemon of the JFS. In the ReiserFS, a journal_begin function that is a command to start a journaling process is internally called to log the metadata, and a journal_end function is called upon the termination of the journaling process to execute a process up to the actual commit.

As illustrated in FIG. 1, the storage system 1 according to the first embodiment is connected to a host device 2 through an LAN 3. In the storage system 1, data that is stored in a backup source storage 20 and to be backed up is backed up by a backup destination storage 30. The storage system 1 includes a backup server 10, the backup source storage 20, and the backup destination storage 30. The storage system 1 backs up data stored in the backup source storage 20 and stores the backup data in the backup destination storage 30.

The backup server 10 manages the backup source storage 20 and the backup destination storage 30. The backup server 10 functions as a control device that causes data stored in the backup source storage 20 to be transferred to the backup destination storage 30 and causes the backup destination storage 30 to back up the data. The backup server 10 includes a processor 11, the memory 12, a memory controller 13, a network I/F 14, a data I/F 15, and a timer (journal timer) 16. The processor 11 executes processes of various types and control of various types. The processor 11 executes a journal transfer program and thereby functions as an acquiring section 11a (described later) and a transferring section 11b (described later). The memory 12 is a random access memory (RAM) or the like and includes a journal region 12a (described later) and a temporary journal region 12b (described later). The memory 12 temporarily stores therein data to be written in the backup source storage 20 and data read from the backup source storage 20. The memory 12 stores therein the journal transfer program and the like. The memory controller 13 controls an operation of the memory 12. The network I/F 14 is connected to and communicates with the host device 2 through the LAN 3. The data I/F 15 is connected to the backup source storage 20 (data I/F 23) and executes data communication with the backup source storage 20. The timer 16 counts a time of Xs seconds corresponding to an interval in which the journal is monitored, as described later. Functions of the processor 11, memory 12, and memory controller 13 and the like are described in detail later.

The backup source storage 20 includes the disks 21, a controller (control device) 22, and data I/Fs 23 and 24. The disks 21 each have a temporary storage region 21a (described later) and store therein data to be accessed by the host device 2 and metadata on the data. The backup source storage 20 includes a plurality of hard disk drives (HDDs) as the disks 21 that form a redundant array of independent disks (RAID). The controller 22 controls, in accordance with instructions from the host device 2 and the backup server 10, access to the disks 21 and transfer of data stored in the disks 21 so that the backup destination storage 30 may back up the data. The data I/F 23 is connected to the backup server 10 (data I/F 15) and executes data communication with the backup server 10. The data I/F 24 is connected to the backup destination storage 30 (data I/F 33) and executes data communication with the backup destination storage 30.

The backup destination storage 30 includes disks 31, a controller (control device) 32, the data I/F 33, and a network I/F 34. The disks 31 store therein backup data stored in the backup source storage 20 (disks 21). The backup destination storage 30 includes a plurality of HDDs as the disks 31 that form a RAID. The controller 32 controls access to the disks 31 and backup of data in accordance with instructions from the host device 2, the backup server 10, and the backup source storage 20. The controller 32 includes a processor 32a and a memory 32b. The processor 32a executes processes of various types and control of various types. The processor 32a executes a journal management program and thereby functions as a list creator 32a1 (described later) and a restorer 32a2 (described later). The memory 32b is a RAM or the like and temporarily stores therein data to be written in the disks 31 and data read from the disks 31. The memory 32b stores therein the journal management program and the like. The data I/F 33 is connected to the backup source storage 20 (data I/F 24) and executes data communication with the backup source storage 20. The network I/F 34 is connected to and communicates with the host device 2 through the LAN 3. Functions and the like of the processor 32a are described in detail later.

In the backup server 10, the processor 11 executes the journal transfer program stored in the memory 12 and thereby functions as an interface that transfers the journal logs of the file system from the backup source storage 20 to the backup destination storage 30. Functions (a1) to (a4) that include functions as the acquiring section 11a and the transferring section 11b, which are achieved by the processor 11 executing the journal transfer program, are described below.

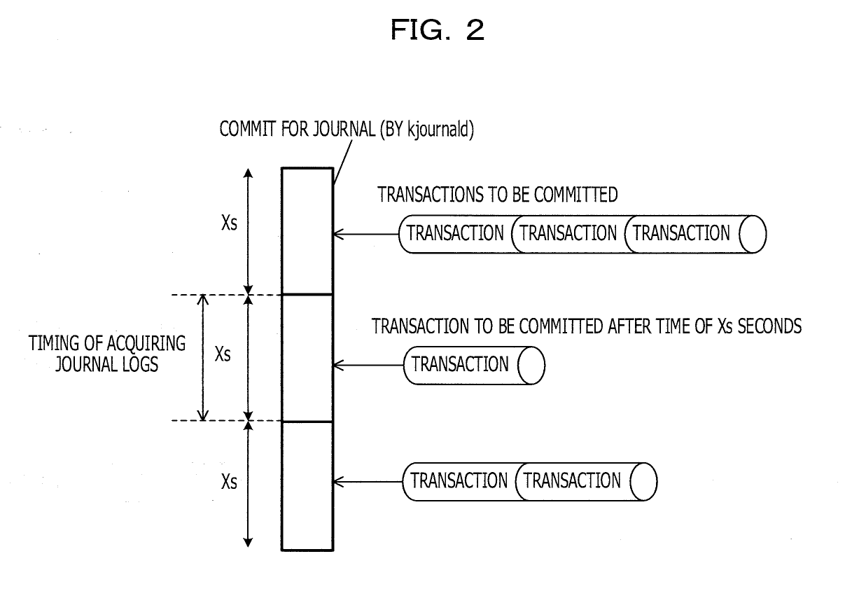

The function (a1) monitors kjournald that is a daemon of Linux and provided for journaling. The commit operation for a transaction is periodically (every Xs seconds in the first embodiment) executed by kjournald that is a kernel thread. The timing of the commit operation is managed by the timer 16 of an operating system (OS). In the first embodiment, the time interval of Xs seconds is counted by the timer 16. When the timer 16 expires for kjournald after the time interval of Xs seconds, a data block (differential data) that corresponds to transaction data is committed from the memory 12 of the backup server 10 to the disks 21 (temporary storage regions 21a) of the backup source storage 20. After that, committed journal logs are written from the journal region 12a (journal buffer I) of the memory 12 of the backup server 10 to the disks 21 (temporary storage regions 21a). The commit for the journal in the storage system 1 is described with reference to FIG. 2. When kjournald is activated from the kernel, a timer list is created. The timer list is executed at the time intervals of Xs seconds. Each of transactions illustrated in FIG. 2 indicates a single entry (single record) of the timer list. Next, each of the transactions sets the timer 16 so that the commit is executed for the timer list after the time of Xs seconds elapses from the current time. When kjournald is activated at the time intervals of Xs seconds and a transaction scheduled to be committed is already registered, the transaction is committed. The commit is writing of data stored in a metadata buffer (not illustrated) of the memory 12 in the disks 21 of the backup source storage 20. For ext3, the commit and a checkpoint (flashing of the buffer 12a, which is included in the memory 12 and stores the journal logs therein, to the disks 21) are installed together in kjournald. Thus, when the commit is completed, the checkpoint is executed.

The function (a2) dumps (acquires) the journal logs. Specifically, this function (a2) serves as the acquiring section 11a that acquires the journal (journal logs) generated in response to a process of changing data stored in the backup source storage 20 as change history information regarding change histories of the data stored in the backup source storage 20. The journal logs are stored in the journal region 12a (journal buffer I) of the memory 12 in response to the change process. The acquiring section 11a acquires the journal logs from the journal region 12a.

The function (a3), which serves as the acquiring section 11a, acquires the journal logs stored in the journal region 12a of the memory 12 and the differential data (differential data block) corresponding to the journal logs and temporarily stores the acquired journal logs and the acquired differential data in the temporary storage region 21a of the backup source storage 20. In this case, the transferring section 11b notifies the processor 32a of the backup destination storage 30 that the data newly updated for the data stored in the backup source storage 20 has been stored. Upon receiving a response to the notification from the processor 32a, the transferring section 11b controls transfer of the journal logs and the differential data stored in the temporary storage region 21a from the backup source storage 20 to the backup destination storage 30. That is, the transferring section 11b transfers the journal logs and the differential data to the backup destination storage 30 upon receiving the response to the notification from the processor 32a.

When data is written from the host device 2 in the journal logs (journal region 12a) during acquisition (dumping) of the journal logs, the function (a4) detects the writing and uses the other journal region 12b on the memory 12 to manage the writing. Specifically, during the acquisition of the journal logs, the acquiring section 11a locks the process of writing the data in the journal region 12a, secures the temporary journal region 12b with the same capacity as the journal region 12a on the memory 12, and writes the data in the temporary journal region 12b (journal buffer II) while locking the process of writing the data in the journal region 12a. After the completion of the acquisition of the journal logs, the acquiring section 11a releases the lock of the process of writing the data in the journal region 12a and migrates the data written in the temporary journal region 12b to the journal region 12a. Note that the processor 11 accesses the memory 12 through the memory controller 13.

In the backup destination storage 30, the processor 32a executes the journal management program stored in the memory 32b and thereby manages the journal received from the backup server 10 through the backup source storage 20. Functions (b1) to (b4) that include functions as the list creator 32a1 and the restorer 32a2, which are achieved by the processor 32a executing the journal management program, are described below.

The function (b1) manages full backup data (fully copied data). In order to back up data in the storage system 1, the data stored in the disks 21 and to be backed up is fully copied into the backup destination storage 30 from the backup source storage 20. Specifically, all the data stored in the disks 21 and to be backed up is first copied into the disks 31 of the backup destination storage 30, and the full backup data is stored in the disks 31. The processor 32a manages the full backup data.

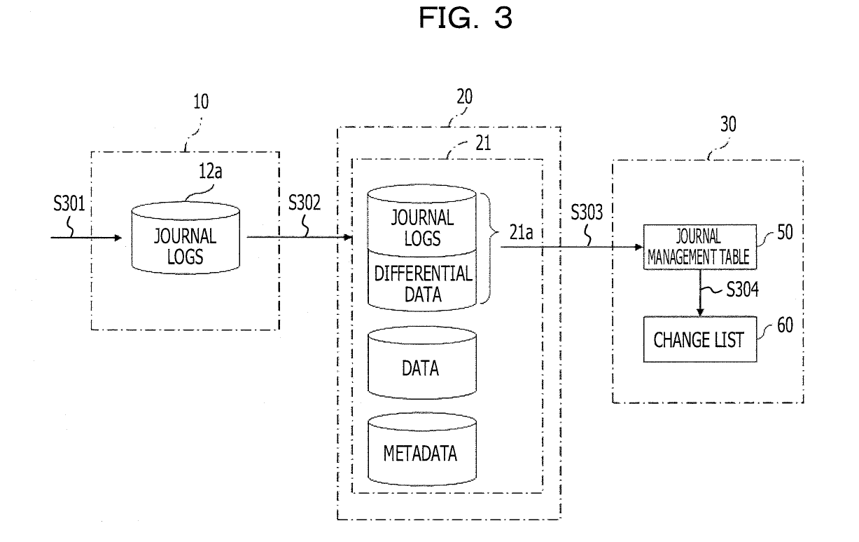

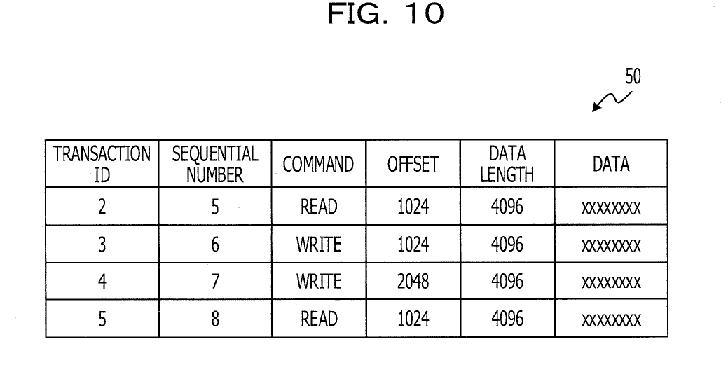

The function (b2) manages the copied journal logs and differential data using a journal management table 50 (refer to FIGS. 3 and 10) with transaction identifications (IDs).

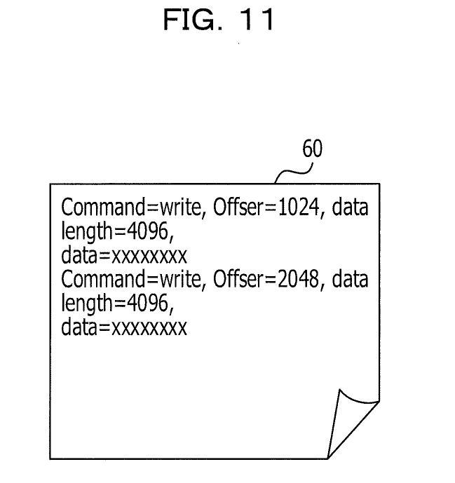

The function (b3) creates a change list 60 (refer to FIGS. 3 and 11) and merges data with the change list 60. Specifically, in the backup destination storage 30, the list creator 32a1 creates, on the basis of journal logs (journal management table 50), the change list 60 listing locations at which data stored in the backup source storage 20 is changed. Especially, the list creator 32a1 creates the change list 60 on the basis of journal logs corresponding to a range specified from outside. In this case, the list creator 32a1 deletes entries (records) corresponding to read commands from the range of the journal logs (journal management table 50) and creates the change list 60.

The function (b4) restores data within the backup source storage 20 at a desired time in accordance with the change list 60 created on the basis of the range specified from outside. Specifically, the restorer 32a2 uses the change list 60 created by the list creator 32a1 and differential data within the backup destination storage 30 to restore the data within the backup source storage 20. In this case, the restorer 32a2 restores the data within the backup source storage 20 at the desired time by reflecting the differential data in the full backup data in accordance with the change list 60 created by the list creator 32a1.

Operations of Storage System According to First Embodiment

Next, operations of the storage system 1 according to the first embodiment configured as described above are described with reference to FIGS. 3 to 12.

First, operations of the storage system 1 according to the first embodiment are described with reference to FIG. 3. FIG. 3 is a diagram illustrating the operations of the storage system 1.

In the first embodiment, all the data stored in the disks 21 and to be backed up is copied into the disks 31 of the backup destination storage 30 at the start of the backup, and the full backup data is stored in the disks 31.

In the first embodiment, the journal file system is used as the storage system 1. In the storage system 1 according to the first embodiment, metadata and change histories of data are stored as journal logs in the journal buffer 12a before writing of the data in the disks 21 in order to improve the consistency of the data (S301).

In the backup server 10, the journal logs within the journal region 12a of the memory 12 and differential data corresponding to the journal logs are acquired by the acquiring section 11a and temporarily stored in the temporary storage region 21a of the backup source storage 20 (S302). After that, the transferring section 11b transfers the journal logs and the differential data that have been stored in the temporary storage region 21a from the backup source storage 20 to the backup destination storage 30 (S303).

In the backup destination storage 30, the journal logs and the differential data are managed by the journal management table 50 with the transaction IDs. For restoration, the change list 60 listing the locations at which the data stored in the backup source storage 20 is changed is created by the list creator 32a1 in response to a request from the host device 2 on the basis of the journal logs (journal management table 50) corresponding to the range specified by the request (S304). Then, the restorer 32a2 restores the data within the backup source storage 20 at the desired time in accordance with the change list 60 created by the list creator 32a1 by reflecting the differential data in the full backup data.

The storage system 1 according to the first embodiment, the processor 11 of the backup server 10 executes the journal transfer program and the processor 32a of the backup destination storage 30 executes the journal management program. In order to back up differential data in the journal file system, journal logs are used in order to ensure the consistency of the journal file system and acquired as information of locations corresponding to the differential data. It is, therefore, possible to suppress a reduction in performance of a business application to the minimum level.

Specific Operations of Storage System According to First Embodiment

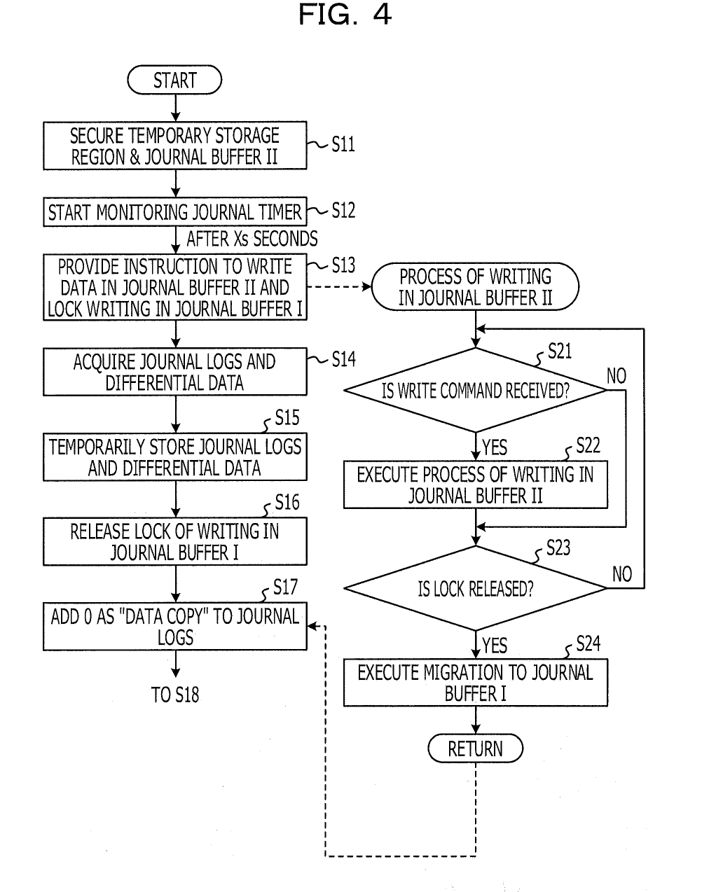

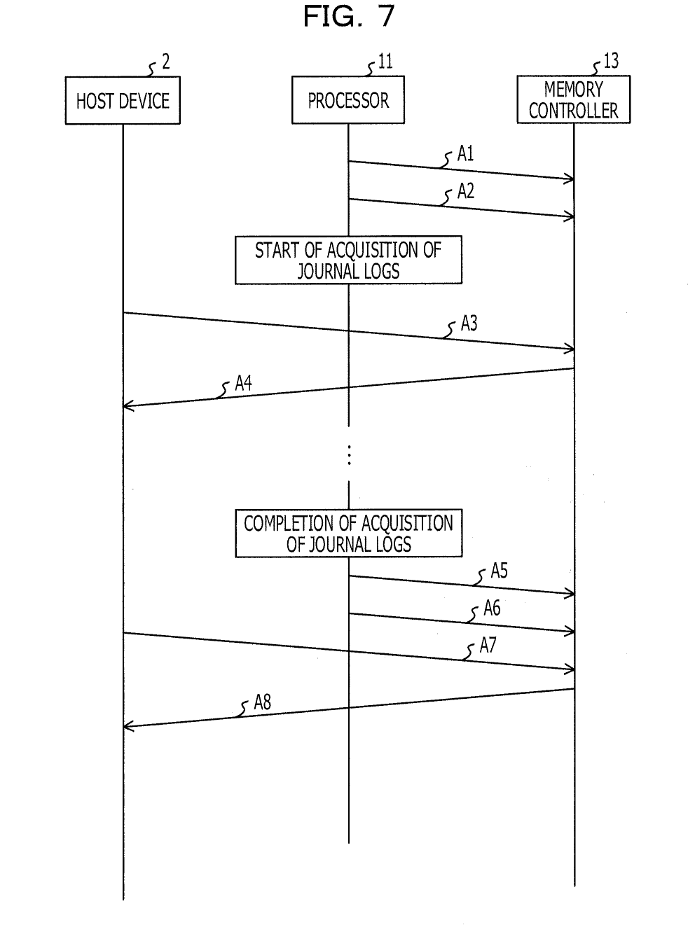

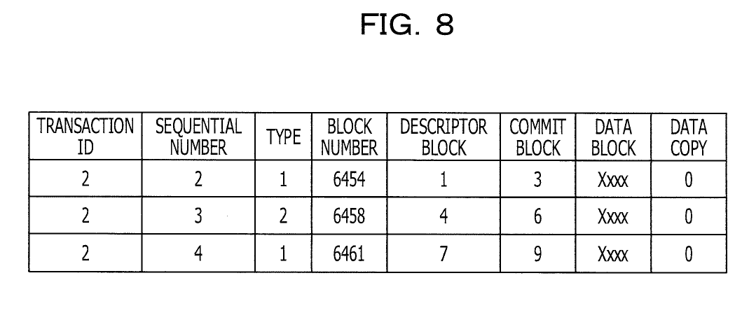

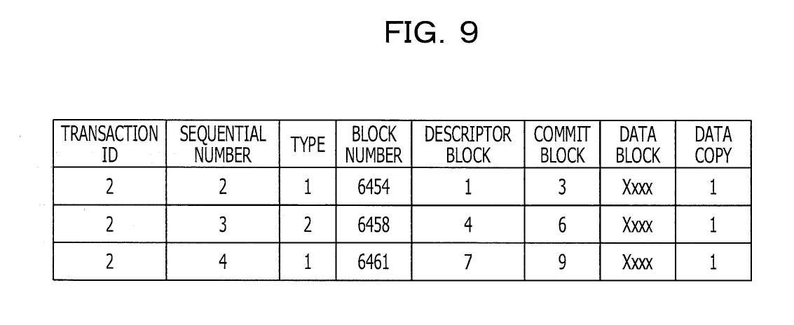

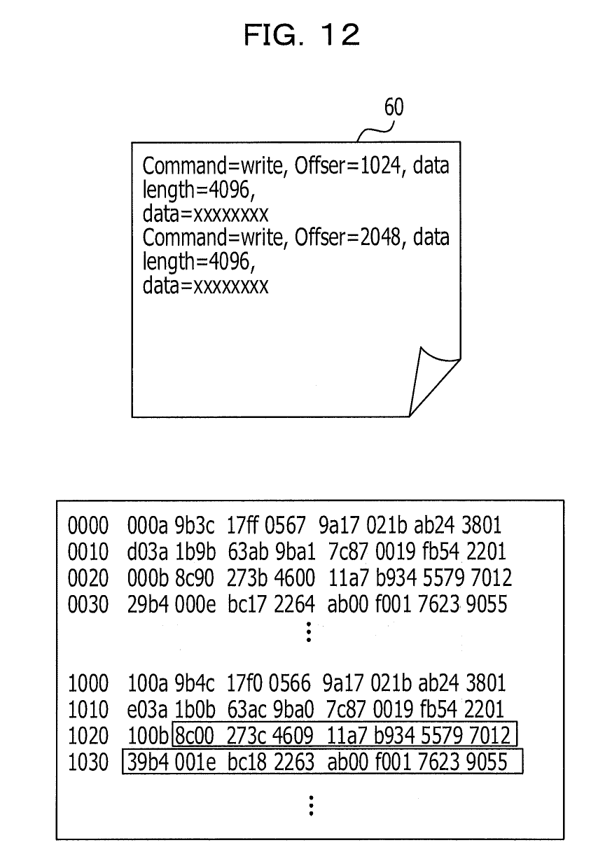

Next, specific operations of the storage system 1 according to the first embodiment are described based on flowcharts illustrated in FIGS. 4 to 6 and a sequence diagram illustrated in FIG. 7 with reference to FIGS. 8 to 12. FIGS. 8 and 9 illustrate specific examples of the journal managed in the first embodiment. FIG. 10 is a diagram illustrating a specific example of the journal management table 50 according to the first embodiment. FIG. 11 is a diagram illustrating a specific example of the change list 60 created from the journal management table 50 illustrated in FIG. 10. FIG. 12 is a diagram illustrating a specific example of backup data restored in accordance with the change list 60 illustrated in FIG. 11.

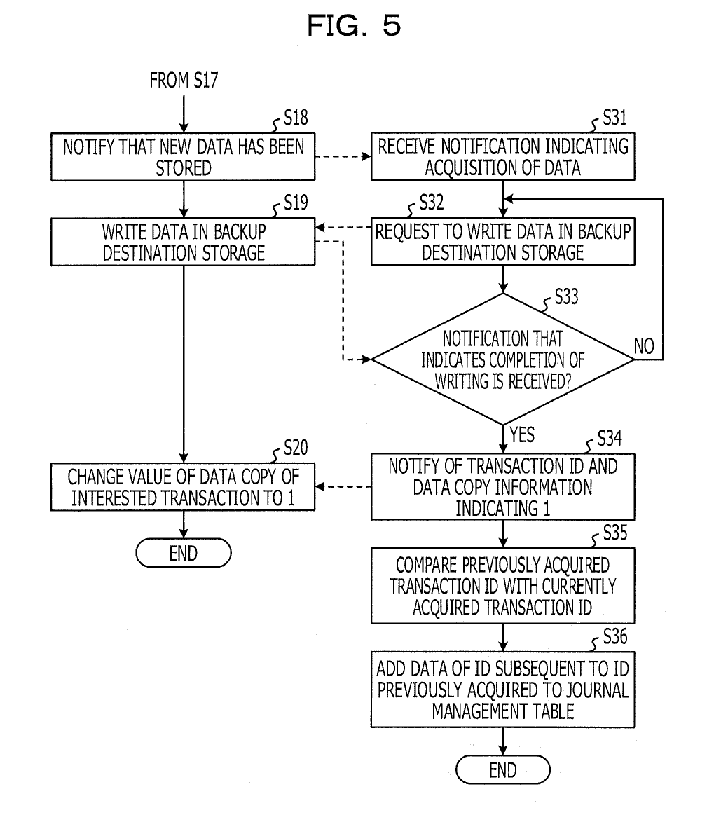

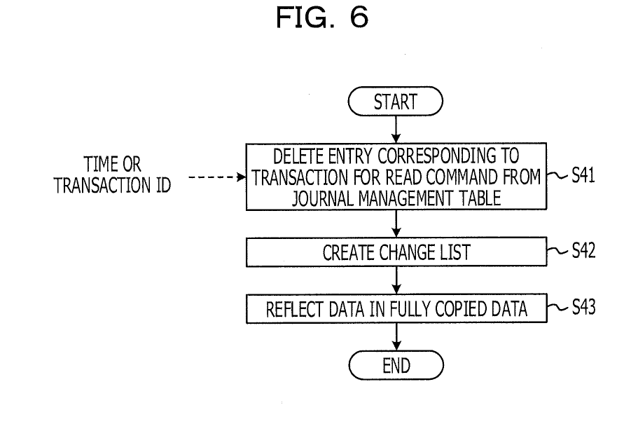

As described above, at the start of the backup, all the data that is stored in the disks 21 and to be backed up is copied into the disks 31 of the backup destination storage 30 using an existing function of a disk array device and all the backup data (fully copied data) is acquired and stored in the disks 31. After that, S11 to S24 illustrated in FIGS. 4 and 5 are performed the processor 11 of the backup server 10 executing the journal transfer program. In addition, S31 to S36 and S41 to S43 illustrated in FIGS. 5 and 6 are performed by the processor 32a of the backup destination storage 30 executing the journal management program.

First, the acquiring section 11a secures, in the disks 21 of the backup source storage 20, the temporary storage regions 21a for temporarily storing copies of journal logs and differential data corresponding to the journal logs. In addition, the acquiring section 11a secures, on the memory 12 of the backup server 10, the temporary journal region 12b (journal buffer II) that has the same capacity as the journal region 12a (journal buffer I) (S11 illustrated in FIG. 4). In the temporary storage region 21a, a region with a capacity that is equal to or larger than the region (journal region 12a on the memory 12) used by the journal file system to manage the journal logs is secured as a region for storing the copies of the journal logs. In addition, in the temporary storage region 21a, a region that has a capacity of 1/10 to ½ of an overall capacity to be used to store data to be backed up is secured as a region for storing the differential data.

After that, the processor 11 of the backup server 10 starts monitoring the timer 16, adds kjournald to a process queue, and starts periodically (at the time intervals of Xs seconds) executing the commit operation for a transaction by kjournald that is the kernel thread (S12). In addition, the processor 11 instructs the memory controller 13 to write data in the journal buffer II and lock the process of writing data in the journal buffer I in order to inhibit data stored in the journal buffer I from being changed (S13; A1 and A2 illustrated in FIG. 7).

After that, when the timer 16 expires for kjournald (or the time of Xs seconds elapses), the acquiring section 11a acquires journal logs of transactions and differential data corresponding to the journal logs (S14). Then, the acquiring section 11a temporarily stores the journal logs acquired from the journal buffer I and the differential data block corresponding to the journal logs in the temporary storage region 21a of the backup source storage 20 (S15). This acquisition process is executed within a time period to the time when the next transaction is completely committed after the time of Xs seconds elapses (refer to the timing of acquiring the journal logs illustrated in FIG. 2). In this manner, after the journal logs and the differential data block are completely copied, the acquiring section 11a releases the lock of the process of writing in the original journal buffer I (S16).

When the backup server 10 receives a command (write command) to write data as the journal logs in the journal buffer I from the host device 2 after the instruction to write the data in the journal buffer II and the instruction to lock the process of writing in the journal buffer I and before the release of the lock, the journal buffer II is accessed in response to the write command. Specifically, during the acquisition of the journal logs, the acquiring section 11a intervenes between an input and output (I/O) driver of the host device 2 and the memory controller 13 and detects an I/O command to input and output the journal logs. Then, the memory controller 13 stores the journal logs corresponding to the detected I/O command in the journal buffer II on the memory 12.

More specifically, the acquiring section 11a monitors reception of the command to write the data as the journal logs in the journal buffer I from the host device 2 or the like during the acquisition process (of S14 and S15) by the acquiring section 11a (S21). If the acquiring section 11a receives the write command (Yes in S21; A3 illustrated in FIG. 7), the acquiring section 11a transmits a preparation completion notification (ready) through the memory controller 13 to the host device 2 or the like (A4 illustrated in FIG. 7) and executes the process of writing the data in the journal buffer II (S22). After the write process or if the acquiring section 11a does not receives the write command (No in S21), the acquiring section 11a determines whether or not the lock of the process of writing in the journal buffer I has been released (S23). If the lock is yet to be released (No in S23), the processor 11 returns the process to S21. If the lock has been released (A5 illustrated in FIG. 7) due to the acquisition of the journal logs (Yes in S23), the acquiring section 11a instructs the memory controller 13 to migrate the data (A6 illustrated in FIG. 7). Thus, the memory controller 13 migrates the data written in the journal buffer II to the original journal buffer I (A7 illustrated in FIG. 7). After that, when receiving a write command from the host device 2 or the like, the memory controller 13 transmits the preparation completion notification to the host device 2 or the like (A8 illustrated in FIG. 7) and the process of writing in the journal buffer I is normally executed.

When the journal logs and the differential data are temporarily stored in the temporary storage region 21a, the acquiring section 11a adds, to the journal logs, data copy information (shown as “data copy” in FIG. 8) that indicates whether or not the journal logs have been transferred and copied to the backup destination storage 30. Since the journal logs are yet to be copied upon the release in S16, “0” is added as the data copy information (“data copy”) to the journal logs, as illustrated in FIG. 8 (S17 illustrated in FIG. 4). After that, the transferring section 11b notifies the processor 32a (of the backup destination storage 30) that the new data has been added or the data newly updated for the data stored in the backup source storage 20 has been stored (S18 illustrated in FIG. 5).

A journal illustrated in FIG. 8 stores, for each of entries (records), items for a transaction ID, a sequential number, a type (indicated by “1” or “2”), a data block number (shown as “block number” in FIG. 8), a start block number (shown as “descriptor block” in FIG. 8), an end block number (shown as “commit block” in FIG. 8), the content (shown as “data block” in FIG. 8) of the data block, and the data copy information.

When receiving a notification indicating the acquisition of the data from the transferring section 11b (S31), the processor 32a executes the following process in order to acquire the journal logs and the differential data from the temporary storage region 21a of the backup source storage 20. Specifically, the processor 32a requests the transferring section 11b of the backup source storage 20 to write the data in the backup destination storage 30 (S32).

Upon receiving the request from the processor 32a in response to the notification, the transferring section 11b controls the journal logs and the differential data that have been stored in the temporary storage region 21a to be transferred from the backup source storage 20 to the backup destination storage 30. Thus, the journal logs and the differential data that have been stored in the temporary storage region 21a are written in the disks 31 of the backup destination storage 30 (S19). When the writing is completed, the transferring section 11b notifies the processor 32a (of the backup destination storage 30) of the completion of the writing.

The processor 32a determines whether or not the processor 32a has received the notification indicating the completion of the writing from the backup source storage 20 (S33). If the processor 32a has yet to receive the notification indicating the completion of the writing (No in S33), the process returns to S32. On the other hand, if the processor 32a has received the notification indicating the completion of the writing (Yes in S33), the processor 32a notifies the processor 11 of an transaction ID of the interested transaction and data copy information (“data copy”) indicating “1” to notify the processor 11 that the data has been copied (S34). The processor 11 that has received the notification updates, from “0” to “1”, the value of the data copy information (“data copy”) included in the journal logs of the temporary storage region 21a and corresponding to the interested transaction (S20), as illustrated in FIG. 9.

The temporary storage regions 21a of the backup source storage 20 are managed by the processor 11. If any of the temporary storage regions 21a does not have a sufficient region to store new journal data, the new journal data is written over the oldest data after it is confirmed that the oldest data has been completely copied into the backup destination storage 30 (or the value of “data copy” is “1”).

After transmitting the notification including the transaction ID and the data copy information (“data copy”) indicating “1”, the processor 32a executes the following process. Specifically, the processor 32a compares the transaction ID of the previously acquired journal log (or the transaction ID of the full backup data first acquired) with the transaction ID of the currently acquired journal log (S35). Then, the processor 32a adds (merges), on the basis of results of the comparison, information of the journal logs of the transaction IDs subsequent to the previous transaction ID to (with) the journal management table 50 obtained when the previous journal log is acquired (S36). The journal logs as well as metadata and data blocks corresponding to the journal logs are managed on the basis of the journal management table 50.

The journal management table 50 is created on the basis of the journal logs from the backup source storage 20. For example, the journal management table 50 is created as illustrated in FIG. 10. The journal management table 50 illustrated in FIG. 10 stores, for each of entries, items for a transaction ID, a sequential number, a command type (shown as “command” in FIG. 10) of “read” or “write”, an offset, the length of data, and the content (shown as “data” in FIG. 10) of the data.

Next, a restoration process (or a procedure of reflecting the differential data in the full backup data first acquired) that is executed by the list creator 32a1 and the restorer 32a2 is described with reference to the flowchart illustrated in FIG. 6.

When a range that identifies data to be reflected is specified with a time or a transaction ID from outside such as a graphical user interface of the host device 2, the list creator 32a1 and the restorer 32a2 execute the following process.

First, the list creator 32a1 deletes, from the journal management table 50, entries included in the specified range and corresponding to transactions for a read command (S41). Thus, only entries corresponding to transactions for a write command are left to be used to update the contents of full backup data. The list creator 32a1 creates the change list (data update list) 60 corresponding to the specified range on the basis of information of the acquired entries included in the specified range and corresponding to the transactions for a write command (S42). For example, the change list 60 is created as illustrated in FIG. 11. The change list 60 illustrated in FIG. 11 stores the commands (only write commands), offsets, the lengths of data, and the contents of the data.

After that, the restorer 32a2 reflects the data of the change list 60 created in the aforementioned manner in the full backup data (fully copied data) first created and stored in the disks 31 of the backup destination storage 30 (S43). Thus, the backup data within the backup source storage 20 at the desired time corresponding to the specified range is restored, for example, as illustrated in FIG. 12. In FIG. 12, frames of solid lines indicate the changed data.

Effects of Storage System According to First Embodiment

In the storage system 1 according to the first embodiment, when differential data of the journal file system is to be backed up, journal logs are used in order to guarantee the consistency of the journal file system and acquired as information (information on the change list 60) of a location of the differential data. Thus, information of a location at which data to be backed up is changed may be acquired without a reduction in the performance of the system, and it is possible to suppress a reduction in the performance of a business application due to the backup to the minimum level.

In this case, since the change list 60 is created using the journal logs, not all regions of metadata are scanned. When access (writing process and reading process) to the journal region 12a (journal buffer I) is locked during the acquisition of the journal logs, and the journal logs stored in the temporary journal region 12b (journal buffer II) are accessed when the journal logs are accessed. Thus, the access to the journal logs is executed without the stop of the system. Since the journal logs are used in order to detect a location of the differential backup data, the metadata is not fully checked and the efficiency of generating backup data may be improved.

In the first embodiment, backup data at any time may be easily restored since all the journal logs are held and the change list 60 is created from the journal logs.

In the first embodiment, entries included in a specified range and corresponding to transactions for a read command are deleted in order to create the change list 60. Thus, the change list 60 is created using only entries corresponding to transactions for a write command to update the contents of the full backup data. Thus, the change list 60 is efficiently created for a short time without consideration of transactions for a read command.

### Other Embodiments

Although the first embodiment is described above, the technique disclosed herein is not limited to the first embodiment. The technique disclosed herein may be variously modified and changed without departing from the spirit of the first embodiment.

The first embodiment describes the case where the processor 11 of the backup server 10 functions as the acquiring section 11a and the transferring section 11b by executing the journal transfer program. The acquiring section 11a and the transferring section 11b, however, may be installed in the backup source storage 20. For example, the controller (control device) 22 included in the backup source storage 20 may function as the acquiring section 11a and the transferring section 11b by executing the journal transfer program. The controller (control device) 22 included in the backup source storage 20 functions as the control device that controls transfer of data stored in the backup source storage 20 to the backup destination storage 30 to back up the data.

In addition, the first embodiment describes the case where the processor 11 of the backup server 10 functions as the acquiring section 11a by executing the journal transfer program. The acquiring section 11a, however, may be installed in the backup destination storage 30. For example, the controller (control device) 32 included in the backup destination storage 30 may function as the acquiring section 11a by executing the journal transfer program. In addition, if an external backup destination server (control device that is not illustrated) that controls the backup destination storage 30 is provided, the backup destination server may function as the acquiring section 11a by executing the journal transfer program. In this case, the backup destination server may function as the list creator 32a1 and the restorer 32a2 by executing the journal management program. In this case, the controller 32 (included in the backup destination storage 30) and the backup destination server function as control devices that control the backup data stored in the backup source storage 20 to be stored in the storage regions (disks 31).

All or parts of the acquiring section 11a, the transferring section 11b, the list creator 32a1, and the restorer 32a2 are achieved by causing a computer (including a processor, a central processing unit (CPU), an information processing device, or any of various types of terminals) to execute a predetermined application program. The application program is a backup program that includes at least the journal transfer program and the journal management program.

The application program is stored in a computer-readable recording medium and provided. The computer-readable recording medium is, for example, a flexible disk, a compact disc (CD) including CD-ROM, CD-R, CD-RW, or the like, a digital versatile disc (DVD) including DVD-ROM, DVD-RAM, DVD-R, DVD-RW, DVD+R, DVD+RW, or the like, or a Blu-ray disc. In this case, the computer reads the application program from the recording medium, transfers and stores the application program to and in an internal or external storage device, and uses the application program.

The computer conceptually includes hardware and an operating system (OS) and means the hardware that operates under control of the OS. If the OS is not used and the hardware is operated by only the application program, the hardware itself corresponds to the computer. The hardware has at least a microprocessor such as a CPU and a unit for reading a computer program stored in the recording medium. The application program includes program codes that cause the computer to achieve the functions of the acquiring section 11a, the transferring section 11b, the list creator 32a1, and the restorer 32a2. A part of the functions may be achieved by the OS instead of the application program.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A storage system comprising:
a backup source storage,
a backup destination storage including a first processor; and
a control device including:
a second processor configured to
acquire change history information on a history of changing data stored in the backup source storage, and
transfer the acquired change history information and differential data corresponding to the change history information to the backup destination storage,
wherein
the first processor is configured to
create, on basis of the change history information, a change list that indicates locations at which the data stored in the backup source storage is changed.

2. The storage system according to claim 1, wherein
the change history information is a journal generated in response to a process of changing the data stored in the backup source storage.

3. The storage system according to claim 2, wherein
the control device further includes a memory that has a first journal region for storing the journal, and
the second processor is configured to
acquire the journal stored in the first journal region and the differential data corresponding to the journal,
store the journal and the differential data in a temporary storage region of the backup source storage, and
instruct the backup source storage to transfer the journal and the differential data from the temporary storage region to the backup destination storage.

4. The storage system according to claim 3, wherein
the second processor is configured to
lock a process of writing data in the first journal region during the acquisition of the journal,
secure a second journal region with a same capacity as the first journal region, and
write, in the second journal region, data to be written in the first journal region while locking the process of writing data in the first journal region.

5. The storage system according to claim 4, wherein
the second processor is configured to
release the lock of the process of writing data in the first journal region after completion of the acquisition of the journal, and
migrate the data written in the second journal region to the first journal region.

6. The storage system according to claim 1, wherein
the first processor is configured to
create the change list on basis of the change history information corresponding to a range specified from outside.

7. The storage system according to claim 1, wherein
the first processor is configured to
delete entries corresponding to a read command from the change history information, and
create the change list on basis of the change history information from which the entries have been deleted.

8. The storage system according to claim 1, wherein
the first processor is further configured to
restore data stored in the backup source storage on basis of the change list and the differential data stored in the backup destination storage.

9. A control device comprising:
a processor configured to
acquire change history information on a history of changing data stored in a backup source storage, and
transfer the acquired change history information and differential data corresponding to the change history information to a backup destination storage.

10. The control device according to claim 9, wherein
the change history information is a journal generated in response to a process of changing the data stored in the backup source storage.

11. The control device according to claim 10, further comprising:
a memory that has a first journal region for storing the journal,
wherein
the processor is configured to
acquire the journal stored in the first journal region and the differential data corresponding to the journal,
store the journal and the differential data in a temporary storage region of the backup source storage, and
instruct the backup source storage to transfer the journal and the differential data from the temporary storage region to the backup destination storage.

12. The control device according to claim 11, wherein
the processor is configured to
lock a process of writing data in the first journal region during the acquisition of the journal,
secure a second journal region with a same capacity as the first journal region, and
write, in the second journal region, data to be written in the first journal region while locking the process of writing data in the first journal region.

13. The control device according to claim 12, wherein
the processor is configured to
release the lock of the process of writing data in the first journal region after completion of the acquisition of the journal, and
migrate the data written in the second journal region to the first journal region.

14. A control device for storing backup data in a storage region, the backup data having been stored in a backup source storage, the control device comprising:
a processor configured to
acquire change history information on a history of changing data stored in the backup source storage and differential data corresponding to the change history information, and
create, on basis of the change history information, a change list that indicates locations at which the data stored in the backup source storage is changed.

15. The control device according to claim 14, wherein
the change history information is a journal generated in response to a process of changing the data stored in the backup source storage.

16. The control device according to claim 14, wherein
the processor is configured to
create the change list on basis of the change history information corresponding to a range specified from outside.

17. The control device according to claim 14, wherein
the processor is configured to
delete entries corresponding to a read command from the change history information, and
create the change list on basis of the change history information from which the entries have been deleted.

18. The control device according to claim 14, wherein
the processor is further configured to
restore data stored in the backup source storage on basis of the change list and the differential data stored in the backup destination storage.
